(19) United States
(12) Patent Application Publication
(10) Pub. No.: US 2010/0040931 A1
(43) Pub. Date: Feb. 18, 2010

(54) INTEGRATION OF ELECTRONICS AND ELECTRICAL DISTRIBUTION INSIDE A FUEL CELL STACK

(75) Inventors: Matthew K. Hortop, Rochester, NY (US); Bernd Peter Elgas, Hilbersheim (DE); Robert S. Foley, Rochester, NY (US); David John Keyes, Rochester, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/190,261

(22) Filed: Aug. 12, 2008

(51) Int. Cl. H01M 2/02

(52) U.S. Cl. 429/34

(57) ABSTRACT

A fuel cell system that includes a single enclosure for all of a fuel cell stack and other stack critical electronics and components, such as power distribution components, voltage monitoring and detecting components, electrical isolation components, etc. The single enclosure offers a number of advantages, such as reduced weight and reduced complexity for service and safety.

### BACKGROUND OF THE INVENTION

1. Field of the Invention

This invention relates generally to an enclosure for a fuel cell stack and, more particularly, to an electrically isolated enclosure for a fuel cell stack where the enclosure also includes various and several electrical components and electronics associated with stack operation.

2. Discussion of the Related Art

Hydrogen is a very attractive fuel because it is clean and can be used to efficiently produce electricity in a fuel cell. A hydrogen fuel cell is an electrochemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

In one known fuel cell system design, the fuel cell stack is mounted in an enclosure, and electrical bus bars are coupled to the stack and connectors mounted to the enclosure. The fuel cell system includes several electronics and electronic modules, such as high voltage disconnect electronics, cell voltage monitoring units, sensors, detectors, etc., that are all part of the fuel cell stack circuit. Typically, these electrical devices and components are mounted in a separate enclosure than the stack enclosure, and are electrically coupled to the stack by high voltage bus bars. This configuration provides a number of disadvantages in the fuel cell system design including the complexity required to dissipate energy from the stack in the necessary time frame to allow service personal to gain access to the enclosures and the dissipation time frame in the event of an accident where emergency personal and others may come in contact with the enclosures.

### SUMMARY OF THE INVENTION

In accordance with the teachings of the present invention, a fuel cell system is disclosed that includes a single enclosure for all of a fuel cell stack and various stack critical circuits, electronics and components, such as power distribution components, voltage monitoring and detecting components, electrical isolation components, etc. The single enclosure for the stack circuitry offers a number of advantages, such as reduced weight, reduced complexity and increased ability for stack service and safety without a complex, costly or bulky apparatus.

Additional features of the present invention will become apparent from the following description and appended claims, taken in conjunction with the accompanying drawings.

### BRIEF DESCRIPTION OF THE DRAWING

FIG. 1 is a schematic diagram of split fuel cell stacks and stack circuitry and electronics within a single enclosure, according to an embodiment of the present invention.

### DETAILED DESCRIPTION OF THE EMBODIMENTS

The following discussion of the embodiments of the invention directed to a fuel cell stack enclosure for a fuel cell stack and high voltage stack electronics is merely exemplary in nature and is in no way intended to limit the invention or its applications or uses.

The present invention proposes integrating electronic and electrical components within a fuel cell stack enclosure in a fuel cell system. As discussed above, known fuel cell systems typically employed separate high voltage enclosures for the stack and the electrical components necessary for stack operation. The present invention integrates the elements in the separate enclosures into a single enclosure, which reduces the space requirement of the system and has a number of other advantages over providing multiple enclosures. The various electrical components and devices include stack critical electronics, circuit boards and power distribution components, such as high voltage monitoring units, electrical isolation components, a high voltage interlock loop (HVIL), voltage detectors, current detectors, etc.

This configuration of fuel cell stack electrical circuitry and components and the fuel cell stack in a single enclosure offers a number of other advantages including reduced stack high voltage interface complexity, improvement of serviceability by enclosing all components with stored energy, eliminating the need for a rapid discharge of stored stack energy in anticipation of system service, and reducing design iteration time by making flexible stack system interfaces, thereby improving the ability to absorb changes to stack design. Improvements in service capabilities are also provided by keeping the stack voltage isolated from the external stack connections.

Further, electronics that are currently mounted to the side of the stack enclosure, such as a cell voltage monitoring unit, high frequency resistance measurement circuits and end cell heater drivers, can be integrated into the same circuit board as the measurement and contactor control system within the enclosure. This reduces the overall volume of the electronics, potentially moves the electronics into a better environment of the enclosure, and simplifies interfaces, thereby reducing design complexity and the number of failure modes. Additional improvements and benefits may result in sharing coolant between the fuel cell stack and other components within the stack enclosure thereby reducing the number of thermal interfaces.

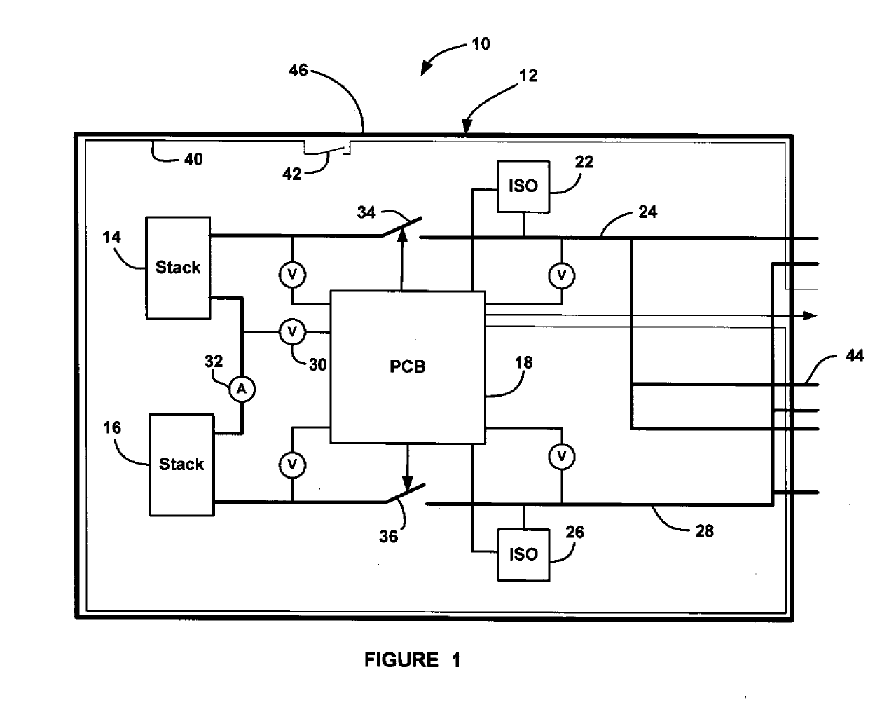

FIG. 1 is a schematic diagram of a fuel cell system 10 including a single stack enclosure 12 that encloses the fuel cell stack and other critical stack electronics, as mentioned above. The specific configuration of the components in the enclosure 12, as will be discussed below, is merely representative and exemplary in that the configuration of the electrical and other components in the enclosure 12 can be in any suitable configuration within the scope of the present invention. In this non-limiting design, the fuel cell stack is actually split sub-stacks 14 and 16, although any number of stacks can be provided within the enclosure 12.

The electrical components within the enclosure 12 include, but are not limited to, at least one or more printed circuit boards (PCB) 18 on which various solid state electrical devices can be provided, such as a cell voltage monitoring unit, high frequency resistance measurement circuits and end cell heater drivers. The PCB 18 can operate as a controller circuit board and can perform various stack operations, such as voltage and current measurements, activate contactors and communicate with the rest of the system. The electrical connections between the components provided in the enclosure 12 and external high voltage components can be made with cables that allow for great flexibility and insulate the design of one side of the interface from changes originating on the opposite side of the interface. The connections from the stack power interfaces to the components within the enclosure 12 can be made with direct connections, such as bolts, during stack construction, which allows for greater tolerances in stack dimensions.

The electrical components also include an electrical resistance measuring circuit 22 for monitoring high voltage isolation between vehicle ground and a positive bus bar 24 electrically coupled to the stacks 14 and 16, and an electrical resistance measuring circuit 26 for monitoring high voltage isolation between vehicle ground and a negative bus bar 28 electrically coupled to the stacks 14 and 16. The electrical components also include several voltage meters 30 for measuring the voltage at different locations within the enclosure 12, and an amp meter 32 for measuring the current flow through the stacks 14 and 16. A switch 34 controlled by circuitry on the PCB 18 disconnects the stacks 14 and 16 from the positive bus line 24 and a switch 36 controlled by circuitry on the PCB 18 disconnects the stacks 14 and 16 from the negative bus line.

The components also include a high voltage interlock loop 40 that extends around the enclosure 12 and is coupled to a lid switch 42. A plurality of interfaces 44 extend out of the enclosure 12 and connect to the various high voltage components in the vehicle, such as an electric traction system (ETS), an air compressor power inverter module (CPIM), etc. In this embodiment, the interfaces 44 can be flexible cables that allow for flexibility and insulate the design of one side of the interface from changes to the other side of the interface.

The components can also include general purpose controller inputs or outputs for measuring sensors or controlling actuators that are located outside of the enclosure 12.

As discussed above, prior fuel cell systems typically employed a separate box for the various stack support circuits that may be mounted to the stack enclosure during system production Such a technique required larger packaging volume and cost to account for an interconnection that is environmentally tight, safe and capable of handling, and does not allow for easy technician insertion of rapidly advancing stack technology or allow for wide tolerances and variations in stack dimensions, which is typical in state-of-the art stack construction. The present invention reduces packaging volume and improves stack design flexibility by adjusting to changes in stack dimensions or power levels without impacting other components and portability of the stacks sub-system from design to design It accomplishes this by locating key functions, such as measurements, contactors and high voltage distribution, inside the stack enclosure 12 as opposed to a separate add-on box.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. An enclosure for holding electrical devices and components in a fuel cell system, said enclosure comprising:
at least one fuel cell stack; and
a plurality of electrical components associated with the at least one fuel cell stack, said plurality of electrical components including power distribution components and cell voltage monitoring components.

2. The enclosure according to claim 1 wherein at least one fuel cell stack is split sub-stacks.

3. The enclosure according to claim 1 wherein the plurality of components includes a controller circuit board.

4. The enclosure according to claim 1 wherein the plurality of components includes a plurality of voltage meters for measuring the voltage at different locations in circuitry within the enclosure.

5. The enclosure according to claim 1 wherein the plurality of components includes general purpose controller inputs or outputs for measuring sensors or controlling actuators that are located outside of the enclosure.

6. The enclosure according to claim 1 wherein the plurality of components includes a high voltage interlock loop.

7. The enclosure according to claim 1 wherein the plurality of components includes at least one electrical resistance measurement circuit for providing high voltage isolation level detection.

8. The enclosure according to claim 1 wherein an interface from the stack enclosure to other circuits is provided by a cable.

9. A fuel cell system comprising:
a stack enclosure;
at least one fuel cell stack mounted within the stack enclosure; and
a plurality of electrical components associated with the at least one fuel cell stack mounted within the stack enclosure, said electrical components including a controller circuit board that controls the operation of electrical components within the stack enclosure.

10. The system according to claim 10 wherein the at least one fuel cell stack is split sub-stacks.

11. The system according to claim 10 wherein the plurality of components includes power distribution components and cell voltage monitoring components.

12. The system according to claim 10 wherein the plurality of components includes a plurality of voltage meters for measuring the voltage at different locations in circuitry within the enclosure.

13. The system according to claim 10 wherein the plurality of components includes general purpose controller inputs or outputs for measuring sensors or controlling actuators that are located outside of the stack enclosure.

14. The system according to claim 10 wherein the plurality of components includes a high voltage interlock loop.

15. The system according to claim 10 wherein the plurality of components includes at least one electrical resistance measurement circuit for providing high voltage isolation detection.

16. The system according to claim 10 wherein an interface from the stack enclosure to other circuits is provided by a cable.

17. A fuel cell system comprising:
a stack enclosure;
at least one fuel cell stack mounted within the stack enclosure; and
a plurality of electrical components associated with the at least one fuel cell stack mounted within the stack enclosure, said electrical components including a controller circuit board that controls the operation of electrical components within the stack enclosure, power distribution components, cell voltage monitoring components, a plurality of voltage meters for measuring the voltage at different locations in circuitry within the enclosure, and at least one electrical resistance measurement circuit for providing high voltage isolation detection.

18. The system according to claim 17 wherein an interface from the stack enclosure to other circuits is provided by a cable.

19. The system according to claim 17 wherein the plurality of components includes general purpose controller inputs or outputs for measuring sensors or controlling actuators that are located outside of the stack enclosure.

20. The system according to claim 17 wherein the plurality of components includes a high voltage interlock loop.
